(19) United States
(12) Patent Application Publication
(10) Pub. No.: US 2011/0066561 A1
(43) Pub. Date: Mar. 17, 2011

(54) Leveraged Usage of Information Regarding Real Estate Offerings

(76) Inventors: Paul E. Lazarre, Chicago, IL (US); Craig Justin Sparling, Chicago, IL (US); Scott J. Hammack, Naples, FL (US)

(21) Appl. No.: 12/845,490

(22) Filed: Jul. 28, 2010

Related U.S. Application Data
(60) Provisional application No. 61/229,038, filed on Jul. 28, 2009.

(51) Int. Cl. G06Q 50/00; G06Q 30/00

(52) U.S. Cl. 705/313

(57) ABSTRACT

A control circuit gathers information regarding a plurality of independent variables for a given real estate offering. The control circuit then uses this information in conjunction with a computer-calculated model to forecast one or more of real estate buyer demand (forward looking), real estate pricing (current market), and real estate marketing effectiveness (forward looking). By one approach this can comprise applying such information in a regression analysis. By one approach, some or all of the aforementioned information can reflect interactions between at least one prospective real estate purchaser on the one hand and a web-based presentation that offers the given real estate offering for sale on the other hand.

### RELATED APPLICATION(S)

This application claims the benefit of U.S. provisional application No. 61/229,038, filed Jul. 28, 2009, which is incorporated by reference in its entirety herein.

This application is related to co-pending and co-owned U.S. patent application Ser. No. 11/873,354, entitled SYSTEM AND METHOD FOR PROVIDING REAL ESTATE LISTINGS and filed Oct. 16, 2007, which is incorporated by reference in its entirety herein.

### TECHNICAL FIELD

This invention relates generally to the offering of real estate.

### BACKGROUND

The offering for sale of real estate comprises a long-established area of endeavor. Generally speaking, this activity involves providing information to one or more potential purchasers regarding the availability of a given parcel of real estate. Amongst a myriad of possibilities this information often at least includes a proposed sales price. In many cases the party looking to sell the real estate contracts with a representative or agent (such as a realtor or real estate broker) to seek out worthy potential purchasers and to provide such information to such parties.

Today's seller can often choose from amongst a wide number and variety of such representatives and brokers. Choosing wisely, however, is often challenging. In many cases the seller lacks useful objective information regarding the relative success that any of these representatives/brokers may likely achieve with respect to selling the seller's particular property. While gross statistics may be available (such as how many real estate parcels a particular realtor has sold during the preceding year, for example), there is little to inform the seller as to more specific concerns (such as, for example, the likelihood that a listing on a particular realtor's website will result in a specific number of showings of the seller's property, which in turn can be expected to result in offers and sales).

Similar problems exist with respect to setting an asking price for a given real estate parcel. It goes without saying that price should reflect demand, but it is less well recognized how difficult it can be to actually assess “demand.” Many so-called real estate forecasting models (such as, for example, the approaches that underlie the Case-Shiller home price index), in fact employ backward-looking indicators. While this can be helpful to understand the real estate market of the recent past, such an approach is often woefully inadequate when attempting to predict the future of that market (and hence the near-term demand for real estate). This confusion and uncertainty with respect to demand, in turn, can lead to inappropriately high (or low) initial asking prices.

### BRIEF DESCRIPTION OF THE DRAWINGS

The above needs are at least partially met through provision of the leveraged usage of information regarding real estate offerings described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a schematic view as configured in accordance with various embodiments of the invention;

FIG. 4 comprises a graph as configured in accordance with various embodiments of the invention;

FIG. 5 comprises a graph as configured in accordance with various embodiments of the invention;

FIG. 6 comprises a representation of a report as configured in accordance with various embodiments of the invention;

FIG. 7 comprises a representation of a report as configured in accordance with various embodiments of the invention;

FIG. 8 comprises a representation of a report as configured in accordance with various embodiments of the invention;

FIG. 9 comprises a representation of a report as configured in accordance with various embodiments of the invention;

FIG. 10 comprises a representation of a report as configured in accordance with various embodiments of the invention; and

FIG. 11 comprises a representation of a report as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit serves to gather information regarding a plurality of independent variables for a given real estate offering. The control circuit then uses this information in conjunction with a computer-calculated model to forecast one or more of real estate buyer demand (forward looking), real estate pricing (current market), and real estate marketing effectiveness (forward looking). By one approach this can comprise applying such information in a regression analysis.

By one approach, some or all of the aforementioned information can reflect interactions between at least one prospective real estate purchaser on the one hand and a web-based presentation that offers the given real estate offering for sale on the other hand.

In at least some application settings, these teachings can express the aforementioned real estate marketing effectiveness prediction as a number or other metric that expresses a calculation regarding an expected number of showings for the given real estate offering. By one approach these showings can comprise in-person showings (as when the prospective buyer and/or their agent physically visit the real estate to make a personal study and assessment of that property). By another approach, in lieu of the foregoing or in combination therewith, these showings can comprise on-line showings that at least meet one or more predefined interaction criteria.

So configured, these teachings permit a user to forecast real estate buyer demand, real estate pricing and/or price trends, and/or real estate marketing effectiveness. By one approach these teachings can serve to compare and contrast, for example, different realtors and/or brokers in these regards. These teachings can also serve to better inform the valuation of a given property for insurance purposes. When employed to assess real estate marketing effectiveness, these teachings can facilitate, for example, meaningful comparisons based upon expected resultant showings and so forth.

Those skilled in the art will appreciate that these teachings offer these benefits with a fresher, more forward-looking point of view than typical prior art approaches in these regards. For example, instead of looking backwards for three months or so, these teachings can provide useful and reliable predictions for three to six months in the future.

These teachings are highly scalable and can readily serve with respect to a wide variety and number of real estate offerings. These teachings are also highly flexible and can serve in a variety of application settings and in reliance upon a wide variety and number of real estate offering variables. Accordingly, through appropriate modification one skilled in the art can leverage these teachings in any number of application settings.

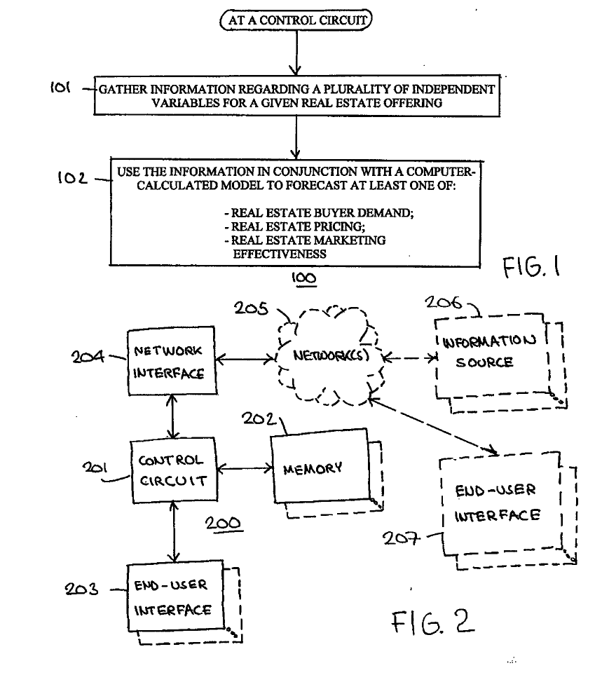

These and other benefits may become clearer upon making a thorough review and study of the following detailed description. Referring now to the drawings, and in particular to FIG. 1, an illustrative process 100 that is compatible with many of these teachings will now be presented.

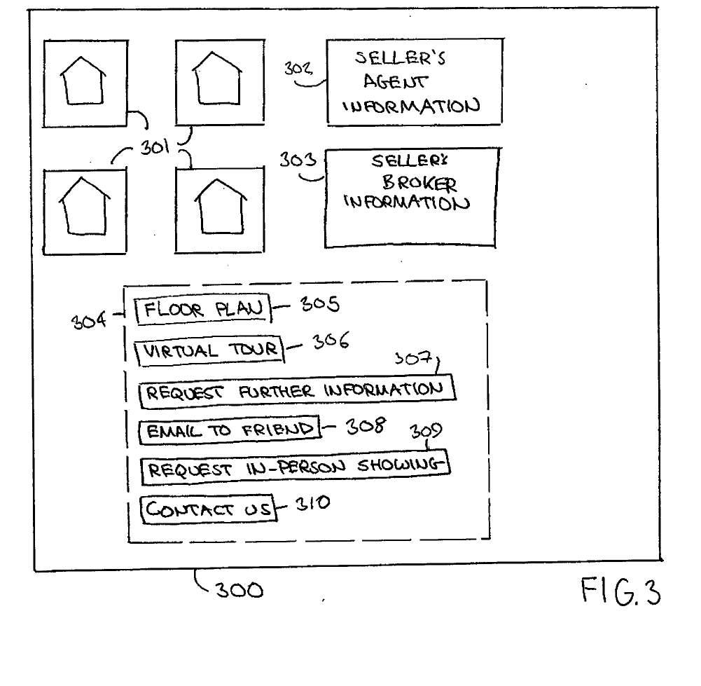

As described, a control circuit of choice carries out this process 100. These teachings will accommodate any number of possibilities in these regards. For the sake of illustration and not by way of limitation, and referring momentarily to FIG. 2, a description of one such approach in these regards will now be presented.

In this illustrative example of a given apparatus 200 the control circuit 201 can comprise a fixed-purpose hard-wired platform or can comprise a partially or wholly programmable platform. All of these architectural options are well known and understood in the art and require no further description here. This control circuit 201 couples to one or more memories 202.

This memory 202 comprises a non-transitory component and can serve, as desired, a variety of purposes. By one approach, for example, this memory 202 can serve to store one or more items of information regarding a given real estate offering. As another example, this memory 202 can serve to store some or all of the programming for the control circuit 201 when the latter comprises a programmable platform. And as yet another example, this memory 202 can serve to store some or all of the results generated by these teachings.

In this example, the control circuit 201 also connects to an end-user interface 203 and a network interface 204. The end-user interface 203 can comprise one or more mechanisms by which an end user imparts information or instructions/commands to the control circuit 201 and/or receives information from the control circuit 201. Non-limiting examples in these regards include keyboards and keypads, cursor-control devices (such as mice, trackballs, joysticks, and so forth), touch-sensitive screens, voice-recognition components, displays, audio transducers, printers, and so forth.

The network interface 204, in turn, serves to communicatively couple the control circuit 201 to one or more networks 205. These networks 205 can comprise any manner of wireless or non-wireless intranets and extranets including, by way of example, the well-known Internet. Via this network interface 204 and these networks 205, the control circuit 201 in turn can communicate with one or more information sources 206 (as described herein), one or more other end-user interfaces 207, and so forth.

Such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform.

Generally speaking, this control circuit 201 is configured (using, for example, corresponding programming as will be well understood by those skilled in the art) to carry out one or more of the steps, actions, and/or functions described herein.

Returning now again to FIG. 1, this process 100 provides the step 101 of gathering information regarding a plurality of independent variables for a given real estate offering. This information can be gathered, for example, from one or more of the information sources 206 described above with respect to FIG. 2. The specific information gathered can and will vary from one application setting to another and can depend, for example, upon the design requirements and/or preferences of a given implementing administrator.

That said, some examples of specific variables that may be considered useful in at least some application settings include (but are not limited to):

List price;

Year built;

Property taxes;

Assessments (if applicable);

Number of bedrooms;

Number of bathrooms;

Square footage;

Selling-price history (possibly adjusted for inflation/deflation);

Location attributes (pertaining, for example, to various positive or negative attributes such as state, city, neighborhood, school district(s), public transportation, walkability index, proximity to shopping and services (either generally or specifically (as regards, for example, specific categories of shopping/services such as groceries, coffee, dry cleaners, laundries, and so forth), sales tax rate, state tax rate, and so forth);

Property attributes (such as type of construction, backyard, type of roof, onsite facilities—gym, doorman, and so forth);

On-line visitor or print (impression) traffic (rated using AdPower (as noted in the aforementioned patent application entitled SYSTEM AND METHOD FOR PROVIDING REAL ESTATE LISTINGS), for example, with respect to the advertising venue such as Realtor.com, Trulia, Chicago Tribune, and so forth;

Lead traffic (such as on-line-based requests for information or chat);

Showing traffic;

Second (or more) showing traffic;

Quality of advertising venue;

Offer prices;

Offer accepted or rejected with the counter-offer price;

Property closings; and

Legal status of property (liens, etc.)

and so forth, to note but a few. These teachings will also accommodate weighting the metrics associated with such variables to reflect local or general differences with respect to the relative importance of the selected variables with respect to one another. For example, in some areas the presence of an on-premises swimming pool might be a sales disincentive (which could be reflected, for example, with a negative weighting such as −2) while in other areas the same swimming pool might be highly desired (which could be reflected, for example, with a positive weighting such as +3).

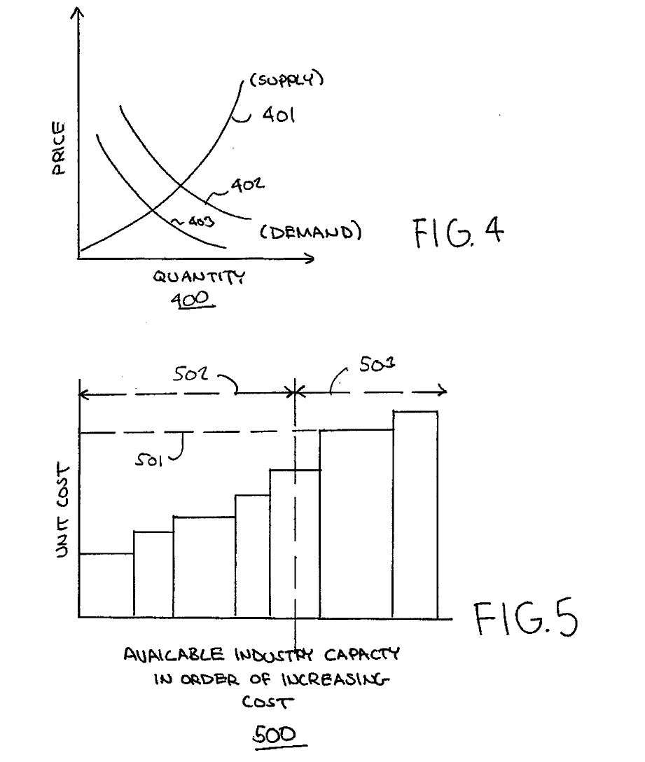

If desired, some or all of this information can represent interactions between one or more prospective real estate purchasers and a web-based presentation that presents the given real estate offering for sale. Numerous examples of such web-based presentations abound in the art. As a simple illustrative representation in these regards, and referring momentarily to FIG. 3, the display 300 of a given website that presents real estate offerings can include (typically) a plurality of selectable photographic images 301 (where selecting the image may, for example, produce an enlarged version thereof) of various views of the property (this example depicts only four available images 301 but it will be understood that dozens or even hundreds of such images can be made available in these regards), an information block 302 that provides information regarding the seller's agent (such as their name, contact information, photographic image, professional accreditation, and so forth), an information block 303 that provides information regarding the seller's broker, and a plurality of selectable links 304.

In this illustrative example these links 304 include a first link 305 to lead to or call up a floor plan for the property, a second link 306 that leads to or calls up a virtual tour of the property, a third link 307 that opens an opportunity for the prospective buyer to request further information (such as a brochure regarding the property, the agent, and/or the broker) be provided (via email, regular mail, and so forth), a fourth link 308 to permit the prospective buyer to email information regarding the property, or a link to lead the email recipient back to this particular website, a fifth link 309 to permit the prospective buyer to request a in-person showing of the property, and a sixth link 310 to permit the prospective buyer to contact the seller, agent, and/or broker (via, for example, email, telephone, mail, or in person as desired).

Pursuant to these teachings, the prospective buyer's interaction with the webpage can be monitored and recorded or otherwise metricized and that information then provided to the control circuit as part of the aforementioned information gathering step. These teachings can note and leverage, for example, knowing that not only did a particular site visitor click on one photograph of the property but four such photographs (where one can reasonably presume that such a visitor has evinced a greater than casual interest in the property by taking these actions).

Those skilled in the art will recognize that there are various ways by which such information can be initially gathered, organized, stored, and then submitted in fulfillment of the aforementioned gathering step. These teachings will readily accommodate submitting such information using one or more standard data formats of choice (such as, but not limited to, fixed length strings, XML data, and so forth). The gathering itself can occur essentially in real time (for example, at a time of need) or can occur on a periodic (such as daily, weekly, monthly, yearly, or the like) or asynchronous basis as desired. (For the sake of illustration, an example data transfer specification in these regards appears at the conclusion of this specification.)

Referring again to FIG. 1, this process 100 then provides the step 102 of using the aforementioned information in conjunction with a computer-calculated model to forecast one or more of current real estate buyer demand, proper real estate pricing (i.e., market appropriate and neither significantly over or under priced), and/or real estate marketing effectiveness. By one approach, and as an illustrative non-limiting example, this can comprise using the information in a regression analysis.

This could comprise, for example, calculating a demand score as corresponds to the given real estate offering. As one illustration in these regards, this might comprise using the following equation:

Yᵢ=β₀+β₁Xᵢ₁+β₂Xᵢ₂+ . . . +βₚXᵢₚ+εᵢ

where i=1, . . . , n, Y=the predicted demand value, β=the parameter estimators, X=the aforementioned independent variables, and ε represents an error term.

The flexibility and use of such an approach can be represented to some extent by referring now to FIGS. 4 and 5. FIG. 4 depicts a demand curve graph 400 having a price axis and a quantity axis (where “quantity” refers to the number of individual real estate offerings are on the market). The curve denoted by reference numeral 401 represents supply and the other two curves (denoted by reference numerals 402 and 403) represent demand under different circumstances. For example, an increase in demand (as calculated as per the foregoing) can be represented here by shifting the demand curve from the position denoted by reference numeral 403 to the position denoted by reference numeral 402. Such an increase in demand might be driven, as one simple example, by an increase in the number of showings being experienced by the property in question or in similar properties.

FIG. 5, in turn, depicts a vertical demand graph 500 having unit cost as a first axis and available industry capacity as the second axis. The phantom line denoted by reference numeral 501 represents a particular market price while the phantom line denoted by reference numeral 502 represents market demand (while the phantom line denoted by reference numeral 503 represents excess capacity). The various blocks shown on the graph 500 depict, in turn, groups of real estate properties at different unit prices.

With the foregoing in mind, a demand score for a particular parcel of real estate can be generated as per these teachings. This might comprise increasing the demand score when a particular event occurs, such as when a website visitor remains online interacting with the information for the given property for more than a given amount of time (such as more than ninety seconds), or when a website visitor views at least a particular number of photos of the property. (By one approach, for example, a sufficient quantity and/or quality of on-line interaction can be considered a “showing” of the property.)

By one approach, the particular threshold (or thresholds) by which the visitor's interaction merits such interpretation can be static and remain unchanged (allowing, of course, for a system administrator to make occasional changes in these regards). By another approach, however, some or all of these thresholds can be automatically and dynamically altered and varied to potentially better track and interpret the monitored interaction. As a simple example in these regards, a total on-line interaction of at least five minutes that includes only one viewing of a photograph may be considered the showing-quality equivalent of an interaction of only two minutes where the visitors views at least ten photographs of the property.

In any event, the actual demand as calculated at any given time (as a reflection, for example, of what may be real time or essentially real time interaction) can reflect an increased, decreased, or maintained demand for a given property. This result can, in turn, be conveyed to an end user in any of a variety of ways. By one approach, simple integers or other values can serve in these regards. By another approach, meters, gauges, color codes, and so forth can be employed to convey such information. Other iconic mechanisms, such as upwardly and downwardly pointing arrows, can also be employed as desired.

As another example in these regards, an initial offering price can be compared to other (real time, if desired) list prices to understand the presence (and direction) of pricing pressure. For example, if a realtor inputs information indicating that the value of an initial offer is only 74% of the asking price, this could be taken as an indication of increased supply or decreased demand. The value or metric assigned to such a variable could, in turn, be weighted upwardly or downwardly to reflect its overall importance in these regards. For example, an accepted offer can be considered more important than a mere offer. These teachings will also accommodate tracking and considering the full negotiating history. For example, the percentage by which the prospective buyer increases their next offer, or the percentage by which the seller counter offers with a reduced asking price, can again be factored in for these purposes. These teachings will further accommodate aggregating such information for a given set of similar properties to leverage the cumulative benefit of such content with respect to predicting and even quantifying changes with respect to supply and demand.

Consider as well the following illustrative example: by maintaining and leveraging a store of data of initial offering terms (including, for example, price, earnest money, and so forth), whether a counter offer (or counter offers) were offered and their details, and whether the parties eventually reached agreement, one could better calculate, for example, that a particular property (such as a 5 bedroom, 4 bathroom, 4,500 square foot home in a particular neighborhood and in a particular school district) will likely sell at this point in time for 92% of a given list price. One might further determine, and by way of a further illustrative example, the lowest offer that has a highest probability (say, for the sake of example, 88%) of receiving a seller's counter offer or the highest low offer having, say, a 100% likelihood of not drawing a counter offer from the seller.

As yet another example of the flexible application of these teachings, one can calculate a demand score for a given list price and then adjust the list price accordingly. For example, when a property is not attracting any showings at a given list price, this information can be gathered as described above and hence taken into account when calculating the present demand score.

As averred to above, these teachings can also be leveraged to calculate telling metrics regarding advertising of the real estate. This can comprise, for example, using this equation:

$$\frac{( RF ) ( Q )}{CP} = S$$

where RF=a variable reflecting reach and frequency of advertising, Q=a variable reflecting quality of the advertising, and CP=a variable reflecting current pricing for the given real estate offering.

Such an equation will yield, for example, a reduced number of predicted showings as the asking price rises with respect to the market-correct asking price. Such an approach can quantify a useful effectiveness metric for brokerages and/or individual agents and hence can be utilized to benchmark various brokerages and/or agents against one another. Such a benchmarking study can of course be further granulated to make such comparisons on the basis of property location, price range, type of property (single-family home versus multi-family dwelling, for example), square footage, property age, renovation history, and so forth as desired.

In all of these cases the equations themselves and/or their calculated results can be adjusted to account for error and/or calibration to reflect any number of local variations and/or unaccounted-for variables or influences. The calculation and application of such corrections or adjustments can be manually determined and/or entered or can be dynamically and automatically realized as desired.

The variety of metrics attainable via these teachings, their temporal relevance and value, their substantive relevance, their great flexibility and scalability, their ease of application and use, and their relative accuracy and dynamic reflection of changing circumstances renders these teachings far superior to present prior art practice in these regards.

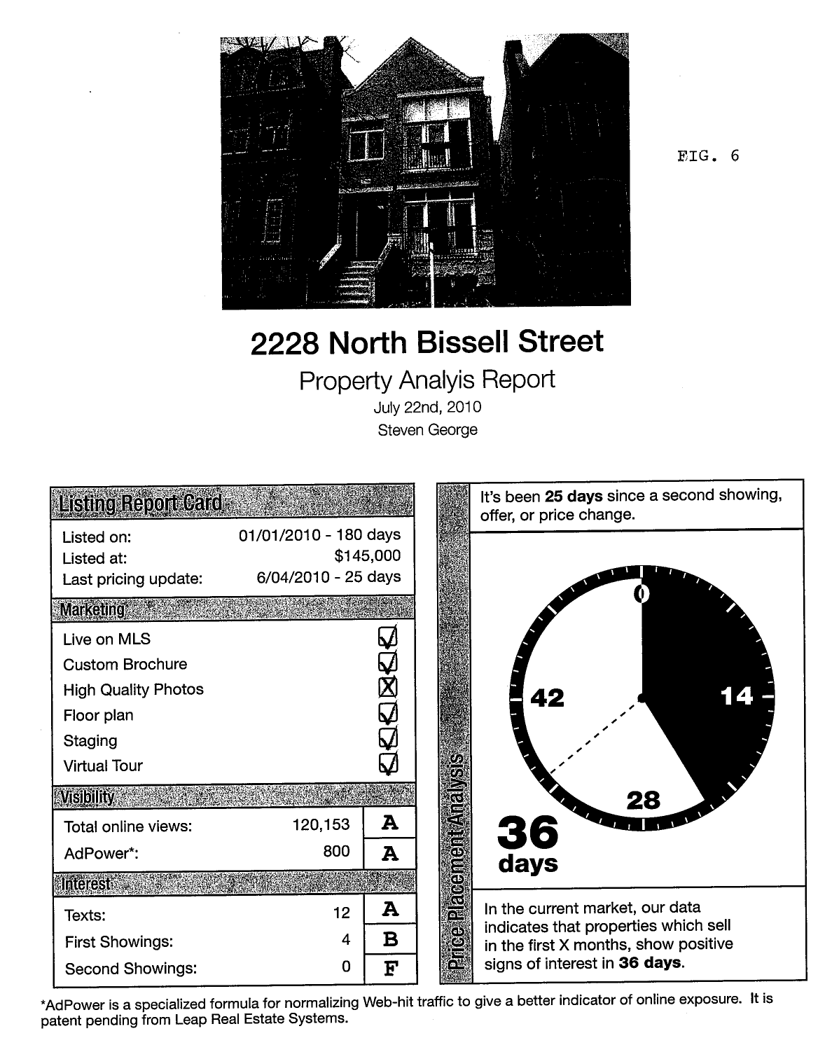

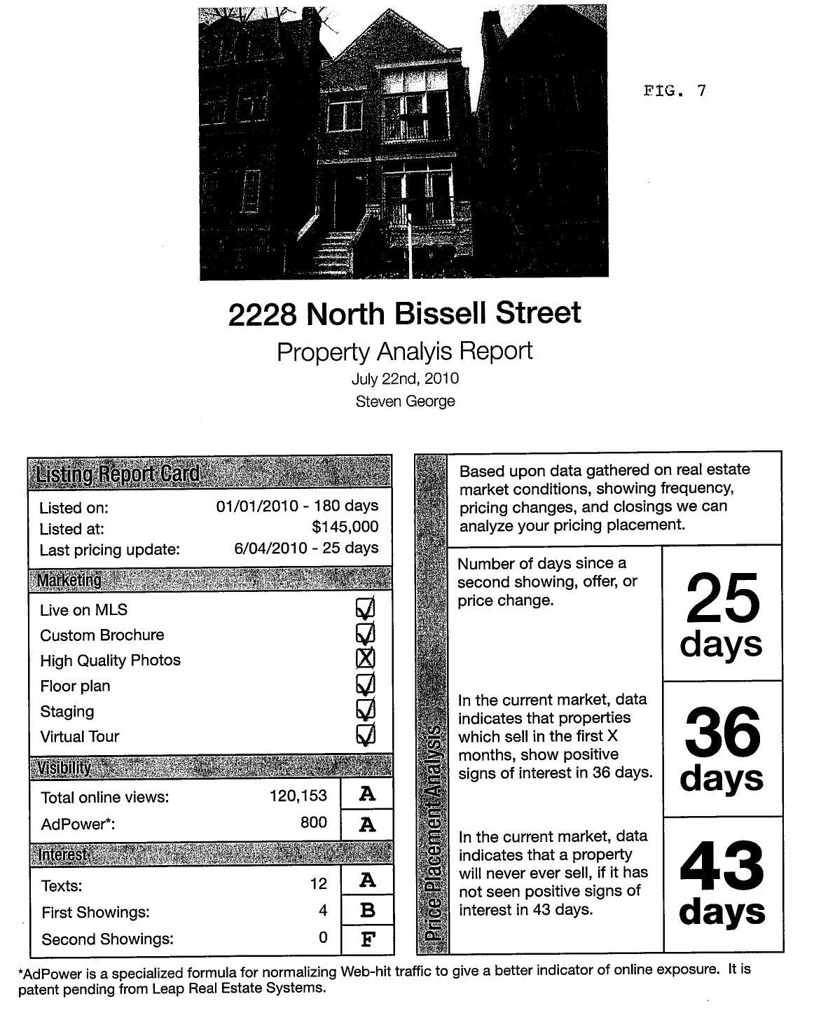

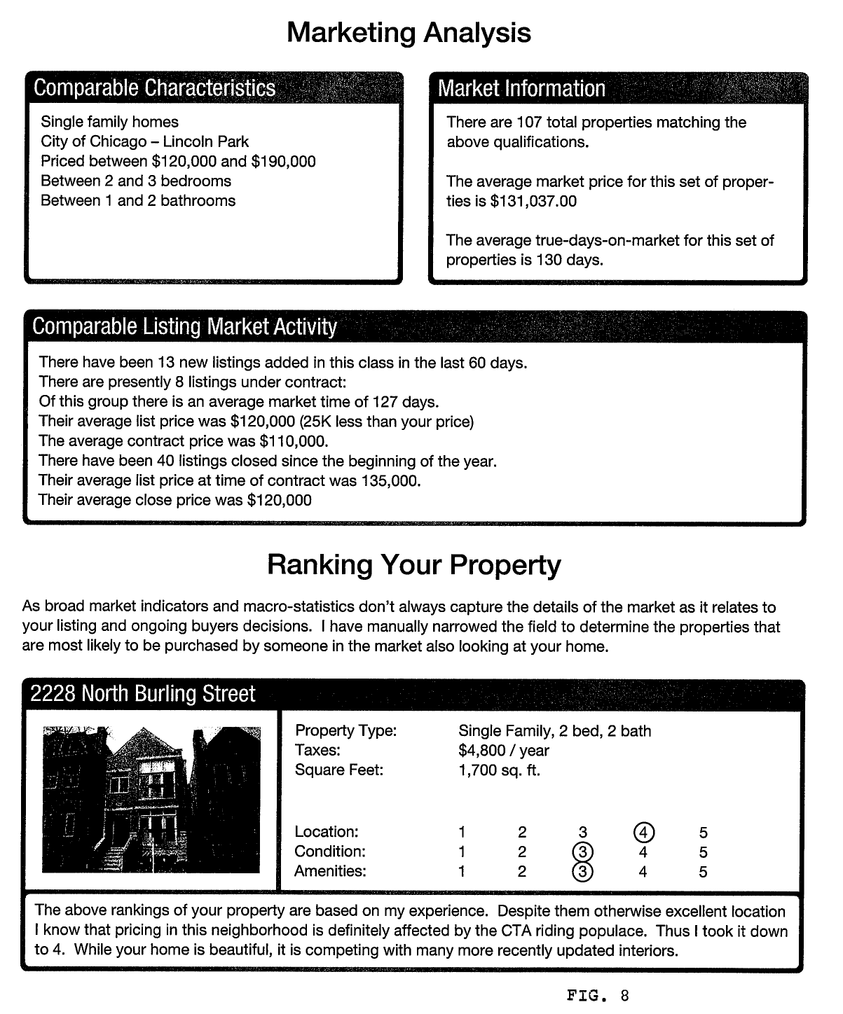

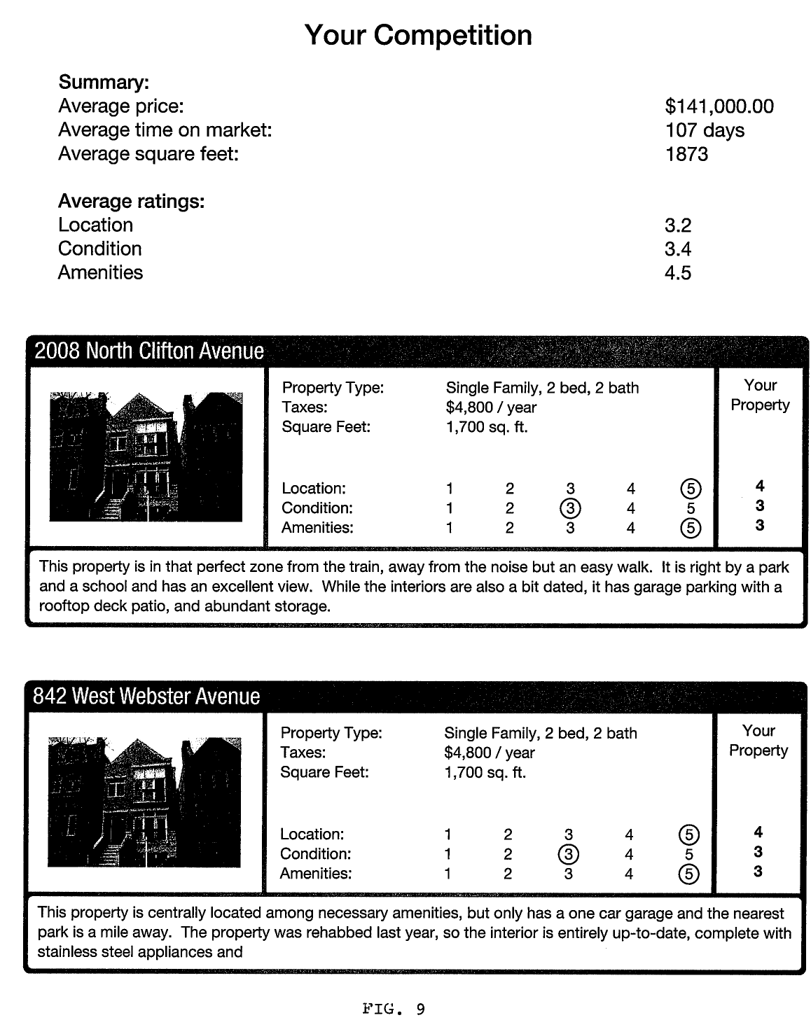

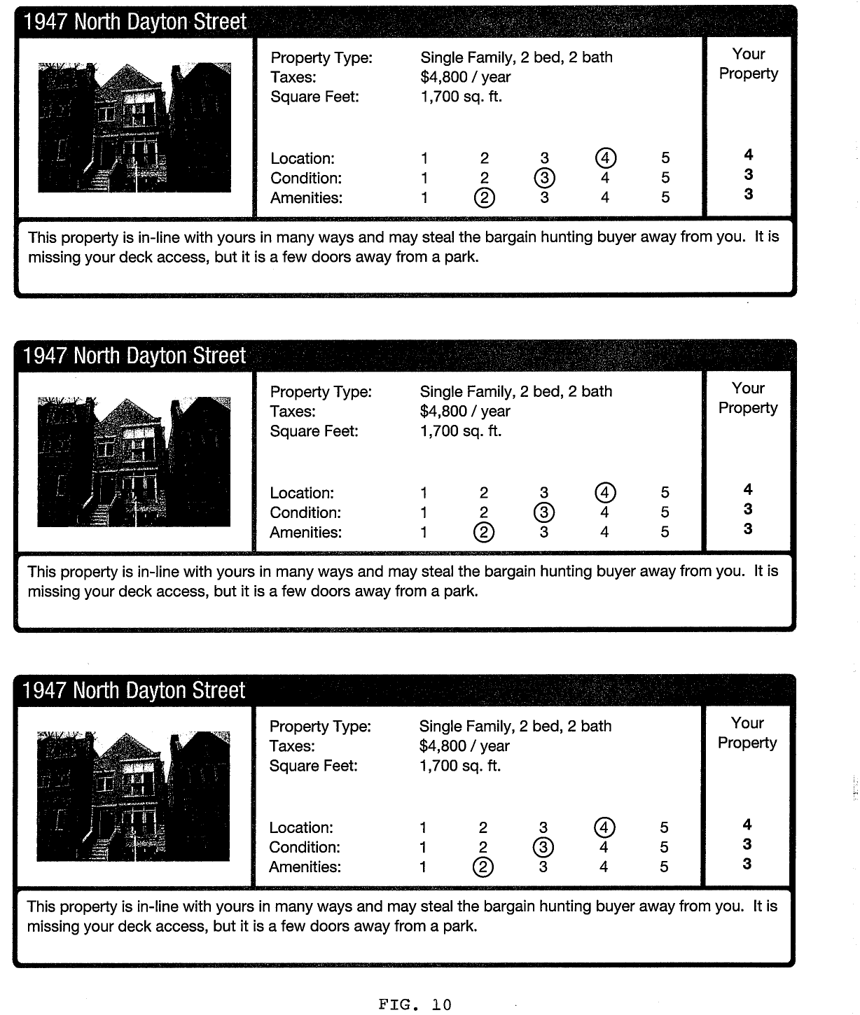

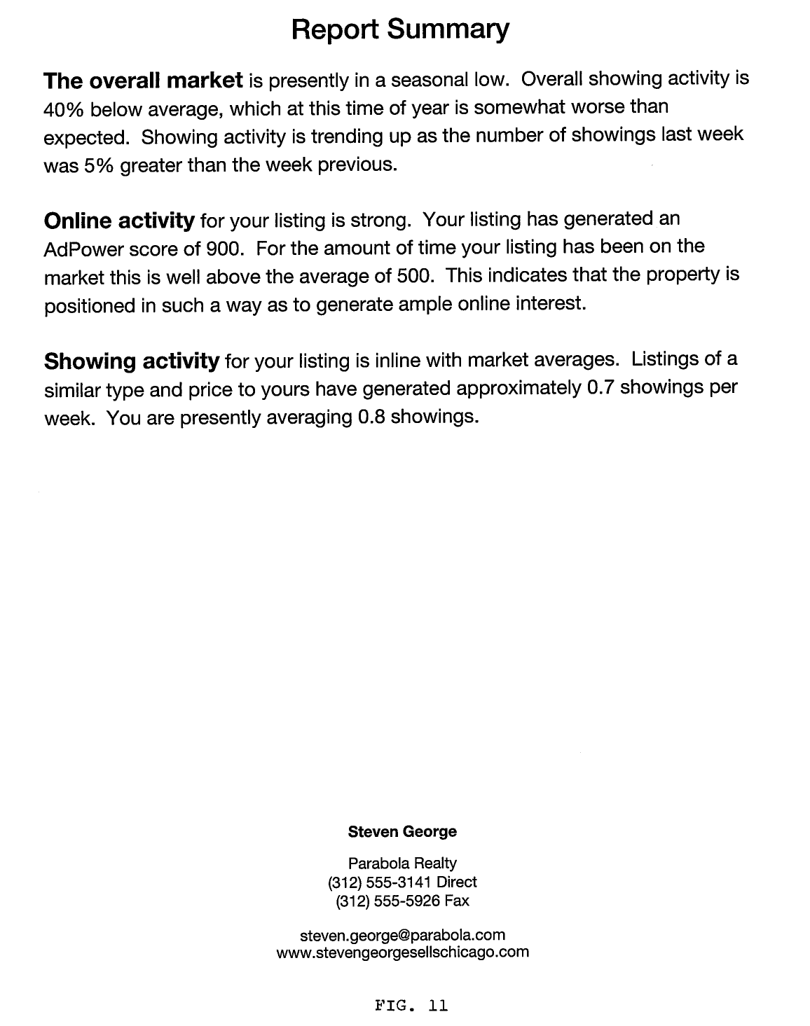

The outputted results as described herein can be conveyed to interested parties in any of a variety of ways. By one approach these teachings will provide for delivering a report on a periodic basis, such as once a week or month, to the sellers of a property. Such a report can contain property information, showing information, property feedback information from showing activity, comparable listing information, and guidance regarding the property's pricing, likelihood of selling within a given period of time, whether a price reduction is needed based on buyer demand, and whether offers have been received in a given timeframe. Additionally the report can contain aggregated in-person and/or virtual showing and on-line traffic data for a given location and/or similar properties to show market performance compared to the property being offered for sale. A non-limiting, illustrative example of such a report appears as FIGS. 6 through 11.

Such a report can also contain a free text area where a user, real estate agent, or brokerage can create a custom page describing local market conditions. This custom data can be universally applied or added based on properties of the listing. Furthermore, as desired, the pages within the report can be categorized into groups including a report for a new listing, a property where the showings are going well in the market and locally with the property, a property where the showings are going well in the market but poorly for that property, and where the showings are poor for the market and the property.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but example in these regards, realtors and other agents can be provided with dedicated portable communication devices (or with appropriate applications that work, for example, with their cellular telephones, laptop computers, and so forth) to permit such persons to enter real time (or near real time) information regarding showings, durations of showings, offers, counter offers, and so forth from the properties themselves, from their vehicles, and so forth for the use described herein. As another related example in these regards, these teachings will accommodate using pushed or pulled forms (calendar-based or otherwise) to elicit the entry of such information from relevant parties such as realtors via their desktop computers, laptops, tablet-based and personal digital assistant platforms, cellular telephones and/or smart phones, and so forth.

By one approach in these regards, comparable properties can be selected manually by a real estate agent or user with some electronic assistant (presuming availability of the data). Data can then be made available as users select similar properties for comparable reporting. For example, if top-performing real estate agent A says that properties 1, 2, and 3 are similar to their property 9, this information could be stored and the success of the agent factored into a weighted score to yield a weighted success score. Therefore, an agent with a high number of online visits, showings, offers, contracts, and/or sales would have a highly-weighted score and this could serve as a kind of validation for their opinions and assessments (in which case, for example, their identification of certain properties as being similar can be taken as likely being correct). If another agent, say, agent B who owns property 2, chooses properties 1 and 9 as similar properties, properties 1 and 9 can be viewed as being very likely to be similar when selecting properties for the comparable report given these complimentary inputs from two separate sources.

As yet another example in these regards, for each property chosen the system can also ask the user to rate the property based on location, condition, and amenities. Free text and additional structured questions can accompany this information. This information can be stored and presented in an adjusted fashion based on the agent's or user's weighted success score.

### Example Data Transfer Specification

| | |
|---|---|
| − | <xml> |
| | <specification>1.3</specification> |
| | <source>AtPropertiesChicago</source> |
| | <date>04/20/2009</date> |
| | <period>day</period> |
| − | <property> |

| | <address>1125 West George Street</address> |
|---|---|
| | <unitnumber /> |
| | <city>Chicago</city> |
| | <state>IL</state> |
| | <zipcode>60657</zipcode> |
| | <country>USA</country> |
| | <lat>82.12345</lat> |
| | <long>−69.1234</long> |
| | <id>7160670</id> |
| | <taxpin>14728301902783</taxpin> |
| | <beds>5</beds> |
| | <baths>2.5</baths> |
| | <listprice>550000</listprice> |
| − | <advertising> |

```
− <venue>
  <name>Craigslist</name>
− <blurbs>
  <blurb>Awesome Wrigleyville Penthouse</blurb>
  </blurbs>
</venue>
```

</advertising>

| | |
|---|---|
| − | <activities> |

| | |
|---|---|
| − | <online> |

<name>Trulia</name>

<id>7382912</id>

| | |
|---|---|
| | <url>http://www.trulia.com/7382912</url> |
| | <timeonline>1952</timeonline> |
| | <pageviews>42</pageviews> |
| | <clickthroughs>30</clickthroughs> |
| − | <promotions> |

| | |
|---|---|
| − | <promotion> |
| | <name>Trulia Pro</name> |
| | <timeonline>45</timeonline> |
| | <pageviews>20</pageviews> |
| | <clickthroughs>10</clickthroughs> |
| | </promotion> |
| − | <promotion> |

<name>Featured Zip-code 60618</name>

<timeonline>91</timeonline>
<pageviews>5</pageviews>
<clickthroughs>3</clickthroughs>

</promotion>

</promotions>

| | |
|---|---|
| − | <photos> |

| | |
|---|---|
| − | <photo> |

<id>1</id>
<timeonline>91</timeonline>
<pageviews>18</pageviews>

| | |
|---|---|
| | </photo> |
| − | <photo> |

<id>2</id>
<timeonline>32</timeonline>
<pageviews>12</pageviews>

</photo>

| | |
|---|---|
| | </photos> |
| − | <virtualtours> |

| | |
|---|---|
| − | <virtualtour> |

<name>VHT HDR PHOTOS</name>

<timeonline>500</timeonline>

<pageviews>10</pageviews>

</virtualtour>

| | |
|---|---|
| | </virtualtours> |
| − | <map> |

| | |
|---|---|
| | <timeonline>243</timeonline> |
| | <pageviews>14</pageviews> |
| − | <requests> |

<print>2</print>

</requests>

| | |
|---|---|
| | </map> |
| − | <requests> |

<brochure>0</brochure>
<emailtofriend>0</emailtofriend>
<showings>0</showings>
<print>0</print>
<savetoflyer>0</savetoflyer>
<markinterested>0</markinterested>
<markmaybeinterested>0</markmaybeinterested>
<marknotinterested>0</marknotinterested>

</requests>

| | |
|---|---|
| | </online> |
| − | <print> |

<name>Postcard Mailing</name>
<description>Sent postcard to zip code list</description>
<datetime>1/1/2009 12:00:00:00</datetime>

<reach>532</reach>

<cost>100</cost>
<comments />

| | |
|---|---|
| | </print> |
| − | <activity> |

<name>Price change calls</name>
<description>Calls to all previous showing agents to notify of price

change.</description>

<datetime>1/1/2009 12:00:00:00</datetime>
<reach>20</reach>
<cost>45</cost>
<comments />

</activity>

| | </activities> | |
|---|---|---|
| − | | <showings> |

| | |
|---|---|
| − | <showing> |

| | |
|---|---|
| | <id>781234</id> |
| − | <resource> |

<name>Mr. My Team</name>
<email>myteam@myteam.com</email>

| | |
|---|---|
| | </resource> |
| − | <attendee> |
| | <name>John Smith</name> |
| | <type>Agent</type> |

| | |
|---|---|
| − | <phonenumbers> |

<cell>312-523-9218</cell>
</phonenumbers>

<email>csparling@leapre.com</email>
<id>130160</id>

</attendee>

<datetime>1/1/200912:00:00:00</datetime>

<length>120</length>
<source>craigslist</source>
<number>1</number>
<confirmed>tentative</confirmed>
<comments />

</showing>

| | |
|---|---|
| | </showings> |
| − | <openhouses> |

| | |
|---|---|
| − | openhouse> |
| | <type>Broker</type> |
| | <length>120</length> |

| | |
|---|---|
| − | <attendees> |
| | <count>4</count> |

| | |
|---|---|
| − | <attendee> |
| | <type>Buyer w/o Agent</type> |
| | <name>Greg LaForce</name> |
| | <email>greg@laforce.com</email> |

</attendee>

</attendees>
<interested>1</interested>
<datetime>1/1/2009 12:00:00:00</datetime>

</openhouse>

| | |
|---|---|
| | </openhouses> |
| − | <offer> |

<number>1</number>

<price>520000</price>

<accepted />

```
  </offer>
  </property>
  </xml>
```

Where times are in seconds and 0=false, 1=true.

I claim:

1. A method comprising:
at a control circuit:
gathering information regarding a plurality of independent variables for a given real estate offering;
using the information in conjunction with a computer-calculated model to forecast at least one of:
real estate supply;
real estate buyer demand;
real estate pricing;
real estate marketing effectiveness.

2. The method of claim 1 wherein gathering information comprises receiving at least some of the information from a real estate offering server.

3. The method of claim 1 wherein at least some of the information from the real estate offering server represents interactions between at least one prospective real estate purchaser and a web-based presentation offering the given real estate offering for sale.

4. The method of claim 1 wherein using the information comprises using at least some of the information in a regression analysis.

5. The method of claim 4 wherein using at least some of the information in a regression analysis comprises using the regression analysis to calculate a corresponding demand score for the given real estate offering.

6. The method of claim 1 wherein using the information in conjunction with a computer-calculated model to forecast real estate marketing effectiveness comprises calculating an expected number of showings for the given real estate offering.

7. The method of claim 6 wherein the showings comprise both:
on-line showings that at least meet at least one predefined interaction criterion; and
in-person showings.

8. The method of claim 6 wherein calculating an expected number of showings for the given real estate offering comprises calculating the expected number of showings using the equation: 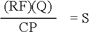
where RF=a variable reflecting reach and frequency of advertising, Q=a variable reflecting quality of the advertising, and CP=a variable reflecting current pricing for the given real estate offering.
